(19) United States
(12) Patent Application Publication
(10) Pub. No.: US 2017/0191548 A1
(43) Pub. Date: Jul. 6, 2017

(54) APPARATUS AND SYSTEM FOR THIN RIM PLANET GEAR FOR AIRCRAFT ENGINE POWER GEARBOX

(71) Applicant: General Electric Company, Schenectady, NY (US)

(72) Inventors: Kenneth Lee Fisher, Schenectady, NY (US); Darren Lee Hallman, Scotia, NY (US); Bugra Han Ertas, Niskayuna, NY (US); Donald Albert Bradley, Cincinnati, OH (US); Haris Ligata, Niskayuna, NY (US); William Howard Hasting, Paris (FR); Ning Fang, Mason, OH (US); Gert Johannes van der Merwe, Lebanon, OH (US); Mark Alan Rhoads, Cincinnati, OH (US)

(21) Appl. No.: 14/984,472

(22) Filed: Dec. 30, 2015

(51) Int. Cl. F16H 1/28; F16H 57/08; F02C 7/36

(52) U.S. Cl. CPC F16H 1/28; F02C 7/36; F16H 57/08; F05D 2260/40311

(57) ABSTRACT

A planet gear includes an annular planet gear ring including an annular planet gear rim. The annular planet gear rim has an inner radius and an outer radius. The inner radius and the outer radius define a rim thickness therebetween. The annular planet gear rim further has a bending stress neutral axis. The bending stress neutral axis radius and the rim thickness define a ratio including values in a range from and including about 3 to and including about 10.

### BACKGROUND

The field of the disclosure relates generally to systems and methods for managing loads on a gearbox in aviation engines and, more particularly, to an apparatus and system for a thin rimmed planet gear in a gearbox in aviation engines.

Aircraft engines typically include a fan, a low pressure compressor, and a low pressure turbine rotationally coupled in a series configuration by a low pressure shaft. The low pressure shaft is rotationally coupled to the low pressure turbine and a power gear box. The power gear box includes a plurality of gears and is rotationally coupled to the low pressure fan and low pressure compressor. Aircraft engines may generate significant torsional loads on the low pressure shaft. Torsional loads on the low pressure shaft can exert torsional forces on the gears within the power gear box. Additionally, if not optimally designed these torsional loads transferred through the planet gears can exert unevenly distributed loads on bearing elements within the planet gears. These unevenly distributed loads result in higher peak roller loads which will induce higher contact stresses between the planet gear, the planet rolling elements, and the planet inner race and reduce the reliability of the planet bearings as well as the power gear box.

### BRIEF DESCRIPTION

In one aspect, a planet gear includes an annular planet gear ring including an annular planet gear rim. The annular planet gear rim has an inner radius and an outer radius. The inner radius and the outer radius define a rim thickness therebetween. The annular planet gear rim further has a bending stress neutral axis. The bending stress neutral axis radius and the rim thickness define a ratio including values in a range from and including about 3 to and including about 10.

In another aspect, a gear assembly includes a sun gear and a ring gear. The gear assembly also includes a plurality of planet gears coupled to the ring gear and the sun gear. Each planet gear of the plurality of planet gears includes an annular planet gear ring including an annular planet gear rim. The annular planet gear rim has an inner radius and an outer radius. The inner radius and the outer radius define a rim thickness therebetween. The annular planet gear rim further has a bending stress neutral axis. The bending stress neutral axis radius and the rim thickness define a ratio including values in a range from and including about 3 to and including about 10.

In yet another aspect, a turbomachine includes a power shaft and a gear assembly. The power shaft is rotationally coupled to the gear assembly. The gear assembly includes a sun gear and a ring gear. The gear assembly also includes a plurality of planet gears coupled to the ring gear and the sun gear. Each planet gear of the plurality of planet gears includes an annular planet gear ring including an annular planet gear rim. The annular planet gear rim has an inner radius and an outer radius. The inner radius and the outer radius define a rim thickness therebetween. The annular planet gear rim further has a bending stress neutral axis. The bending stress neutral axis radius and the rim thickness define a ratio including values in a range from and including about 3 to and including about 10.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary gas turbine engine;

FIG. 2 is a schematic diagram of an exemplary epicyclic gear train that is used with the gas turbine engine shown in FIG. 1;

FIG. 3 is a schematic diagram of an exemplary planet gear that is used with the epicyclic gear train shown in FIG. 2; and

FIG. 4 is a schematic diagram of the planet gear shown in FIG. 3 with resultant tangential and radial forces causing the planet gear ring to deflect.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the thin rimmed planet gear described herein manage resultant tangential and radial loads in a power gearbox in a turbomachine, e.g. an aircraft engine. The thin rimmed planet gear includes a planet gear rim, a plurality of gear teeth, an annular inner bearing ring, and a plurality of rolling elements. The rolling elements are disposed circumferentially around the annular inner bearing ring. The planet gear rim circumscribes and rotates about the rolling elements. The gear teeth are disposed circumferentially about an outer radial surface of the planet gear rim. A sun gear and a low pressure power shaft are configured to rotate the thin rimmed planet gear through a plurality of complementary teeth circumferentially spaced about a radially outer periphery of the sun gear. The low pressure power shaft exerts torsional forces on the sun gear which exerts forces through the planet gear balanced by equal and opposite forces on the ring gear and creates a reaction force through the rolling elements and the pin. The planet gear rim of the thin rimmed planet gear deflects and more evenly distributes the forces across the rolling elements. Better distribution of the forces across a maximum number of rolling elements reduces the contact stresses on the planet gear bearing surface, the rolling elements, and the inner race and increases the reliability of the planet bearing and the power gear box. A planet gear with the proper planet gear rim thickness will deflect enough, but not too much, such that the reliability of planet bearing is increased.

The planet gear described herein offers advantages over known planet gears in aircraft engines. More specifically, the thin rimmed planet gear described herein deflects as resultant radial and tangential forces are applied to it from the sun gear and from the ring gear. Planet gear rim deflection more evenly distributes the forces across the rolling elements which decreases the contact stresses on the planet gear bearing surface, the rolling elements, and the inner race and increases the reliability of the planet bearing and the power gearbox. Furthermore, the thin rimmed planet gear described herein reduces the weight of the aircraft by reducing the amount of material in the planet gear.

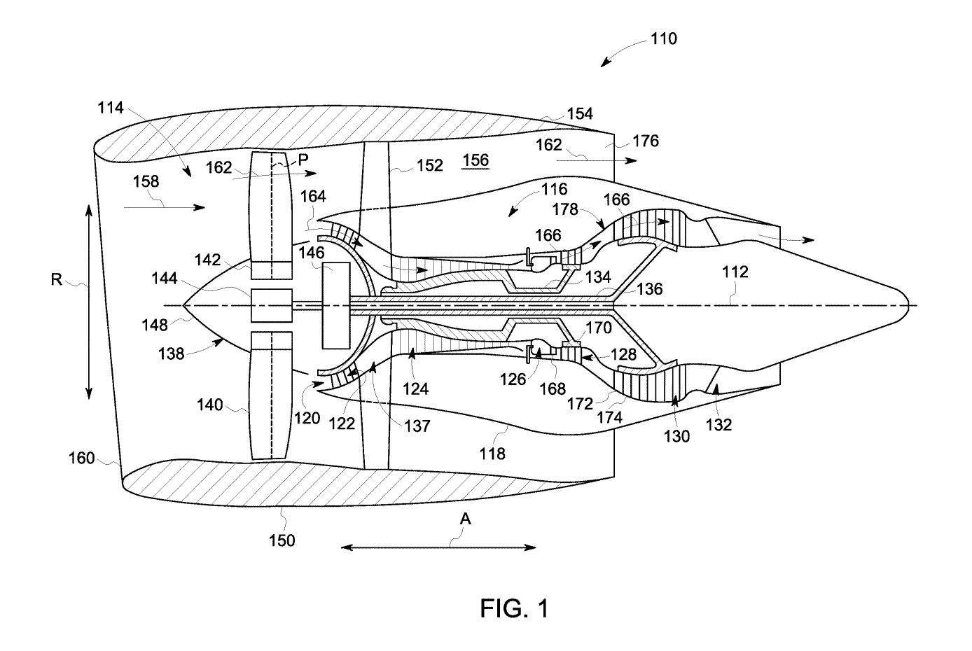

FIG. 1 is a schematic cross-sectional view of a gas turbine engine 110 in accordance with an exemplary embodiment of the present disclosure. In the exemplary embodiment, gas turbine engine 110 is a high-bypass turbofan jet engine 110, referred to herein as “turbofan engine 110.” As shown in FIG. 1, turbofan engine 110 defines an axial direction A (extending parallel to a longitudinal centerline 112 provided for reference) and a radial direction R. In general, turbofan engine 110 includes a fan section 114 and a core turbine engine 116 disposed downstream from fan section 114.

Exemplary core turbine engine 116 depicted generally includes a substantially tubular outer casing 118 that defines an annular inlet 120. Outer casing 118 encases, in serial flow relationship, a compressor section 123 including a booster or low pressure (LP) compressor 122 and a high pressure (HP) compressor 124; a combustion section 126; a turbine section including a high pressure (HP) turbine 128 and a low pressure (LP) turbine 130; and a jet exhaust nozzle section 132. A high pressure (HP) shaft or spool 134 drivingly connects HP turbine 128 to HP compressor 124. A low pressure (LP) shaft or spool 136 drivingly connects LP turbine 130 to LP compressor 122. The compressor section 123, combustion section 126, turbine section, and nozzle section 132 together define a core air flowpath 137.

For the embodiment depicted, fan section 114 includes a variable pitch fan 138 having a plurality of fan blades 140 coupled to a disk 142 in a spaced apart manner. As depicted, fan blades 140 extend outwardly from disk 142 generally along radial direction R. Each fan blade 140 is rotatable relative to disk 142 about a pitch axis P by virtue of fan blades 140 being operatively coupled to a suitable pitch change mechanism 144 configured to collectively vary the pitch of fan blades 140 in unison. Fan blades 140, disk 142, and pitch change mechanism 144 are together rotatable about longitudinal axis 112 by LP shaft 136 across a power gear box 146. Power gear box 146 includes a plurality of gears for adjusting the rotational speed of fan 138 relative to LP shaft 136 to a more efficient rotational fan speed. In an alternative embodiment, fan blade 140 is a fixed pitch fan blade rather than a variable pitch fan blade.

Also, in the exemplary embodiment, disk 142 is covered by rotatable front hub 148 aerodynamically contoured to promote an airflow through plurality of fan blades 140. Additionally, exemplary fan section 114 includes an annular fan casing or outer nacelle 150 that circumferentially surrounds fan 138 and/or at least a portion of core turbine engine 116. Nacelle 150 is configured to be supported relative to core turbine engine 116 by a plurality of circumferentially-spaced outlet guide vanes 152. A downstream section 154 of nacelle 150 extends over an outer portion of core turbine engine 116 so as to define a bypass airflow passage 156 therebetween.

During operation of turbofan engine 110, a volume of air 158 enters turbofan engine 110 through an associated inlet 160 of nacelle 150 and/or fan section 114. As volume of air 158 passes across fan blades 140, a first portion of air 158 as indicated by arrows 162 is directed or routed into bypass airflow passage 156 and a second portion of air 158 as indicated by arrow 164 is directed or routed into core air flowpath 137, or more specifically into LP compressor 122. The ratio between first portion of air 162 and second portion of air 164 is commonly known as a bypass ratio. The pressure of second portion of air 164 is then increased as it is routed through HP compressor 124 and into combustion section 126, where it is mixed with fuel and burned to provide combustion gases 166.

Combustion gases 166 are routed through HP turbine 128 where a portion of thermal and/or kinetic energy from combustion gases 166 is extracted via sequential stages of HP turbine stator vanes 168 that are coupled to outer casing 118 and HP turbine rotor blades 170 that are coupled to HP shaft or spool 134, thus causing HP shaft or spool 134 to rotate, thereby supporting operation of HP compressor 124. Combustion gases 166 are then routed through LP turbine 130 where a second portion of thermal and kinetic energy is extracted from combustion gases 166 via sequential stages of LP turbine stator vanes 172 that are coupled to outer casing 118 and LP turbine rotor blades 174 that are coupled to LP shaft or spool 136, thus causing LP shaft or spool 136 to rotate which causes power gear box 146 to rotate LP compressor 122 and/or rotation of fan 138.

Combustion gases 166 are subsequently routed through jet exhaust nozzle section 132 of core turbine engine 116 to provide propulsive thrust. Simultaneously, the pressure of first portion of air 162 is substantially increased as first portion of air 162 is routed through bypass airflow passage 156 before it is exhausted from a fan nozzle exhaust section 176 of turbofan engine 110, also providing propulsive thrust. HP turbine 128, LP turbine 130, and jet exhaust nozzle section 132 at least partially define a hot gas path 178 for routing combustion gases 166 through core turbine engine 116.

Exemplary turbofan engine 110 depicted in FIG. 1 is by way of example only, and that in other embodiments, turbofan engine 110 may have any other suitable configuration. It should also be appreciated, that in still other embodiments, aspects of the present disclosure may be incorporated into any other suitable gas turbine engine. For example, in other embodiments, aspects of the present disclosure may be incorporated into, e.g., a turboprop engine.

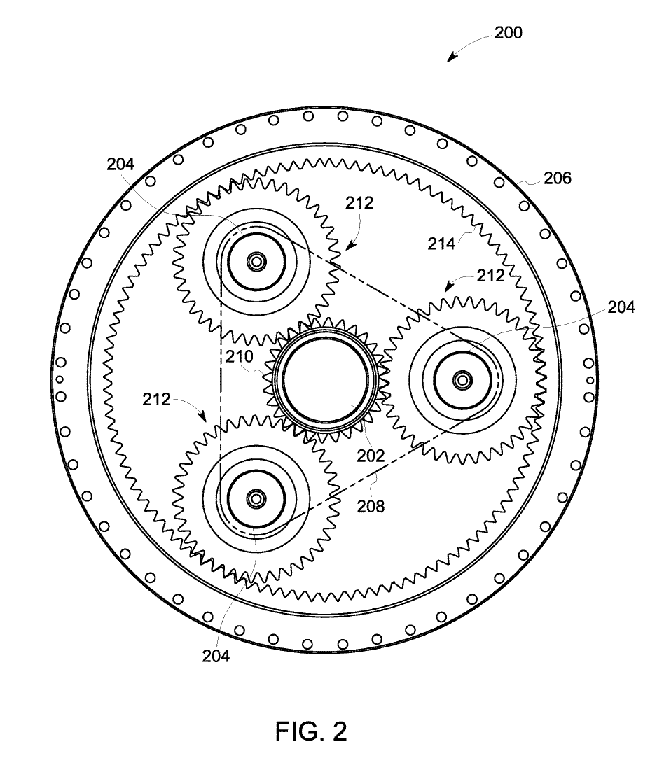

FIG. 2 is a schematic diagram of an epicyclic gear train 200. In the exemplary embodiment, epicyclic gear train 200 is a planetary gear train. In one embodiment, epicyclic gear train 200 is housed within power gearbox 146 (shown in FIG. 1). In other embodiments, epicyclic gear train 200 is located adjacent to power gearbox 146 and is mechanically coupled to it.

Epicyclic gear train 200 includes a sun gear 202, a plurality of planetary gears 204, a ring gear 206, and a carrier 208. In alternative embodiments, epicyclic gear train 200 is not limited to three planetary gears 204. Rather, any number of planetary gears may be used that enables operation of epicyclic gear train 200 as described herein. In some embodiments, LP shaft or spool 136 (shown in FIG. 1) is fixedly coupled to sun gear 202. Sun gear 202 is configured to engage planetary gears 204 through a plurality of complementary sun gear teeth 210 and a plurality of complementary planet gear teeth 212 circumferentially spaced about a radially outer periphery of sun gear 202 and a radially outer periphery of planetary gears 204 respectively. Planetary gears 204 are maintained in a position relative to each other using carrier 208. Planetary gears 204 are fixedly coupled to power gearbox 146. Planetary gears 204 are configured to engage ring gear 206 through a plurality of complementary ring gear teeth 214 and complementary planet gear teeth 212 circumferentially spaced about a radially inner periphery of ring gear 206 and a radially outer periphery of planetary gears 204 respectively. Ring gear 206 is rotationally coupled to fan blades 140 (shown in FIG. 1), disk 142 (shown in FIG. 1), and pitch change mechanism 144 (shown in FIG. 1) extending axially from ring gear 206. LP turbine 130 rotates the LP compressor 122 at a constant speed and torque ratio which is determined by a function of ring gear teeth 214, planet gear teeth 212, and sun gear teeth 210 as well as how power gearbox 146 is restrained.

Epicyclic gear train 200 can be configured in three possible configuration: planetary, star, and solar. In the planetary configuration, ring gear 206 remains stationary while sun gear 202, planetary gears 204, and carrier 208 rotate. LP shaft or spool 136 drives sun gear 202 which is configured to rotate planetary gears 204 that are configured to rotate carrier 208. Carrier 208 drives fan blades 140, disk 142, and pitch change mechanism 144. Sun gear 202 and carrier 208 rotate in the same direction.

In the star configuration, carrier 208 remains stationary while sun gear 202 and ring gear 206 rotate. LP shaft or spool 136 drives sun gear 202 which is configured to rotate planetary gears 204. Planetary gears 204 are configured to rotate ring gear 206 and carrier 208 is fixedly coupled to power gearbox 146. Carrier 208 maintains planetary gears 204 positioning while allowing planetary gears 204 to rotate. Ring gear 206 is rotationally coupled to fan blades 140, disk 142, and pitch change mechanism 144. Sun gear 202 and ring gear 206 rotate in opposite directions.

In the solar configuration, sun gear 202 remains stationary while planetary gears 204, ring gear 206, and carrier 208 rotate. LP shaft or spool 136 can drive either the ring gear 206 or carrier 208. When LP shaft or spool 136 is coupled to carrier 208, planetary gears 204 are configured to rotate ring gear 206 which drives fan blades 140, disk 142, and pitch change mechanism 144. Ring gear 206 and carrier 208 rotate in the same direction.

In the solar configuration where LP shaft or spool 136 is coupled to ring gear 206, ring gear 206 is configured to rotate planetary gears 204 and carrier 208. Carrier 208 drives fan blades 140, disk 142, and pitch change mechanism 144. Ring gear 206 and carrier 208 rotate in the same direction.

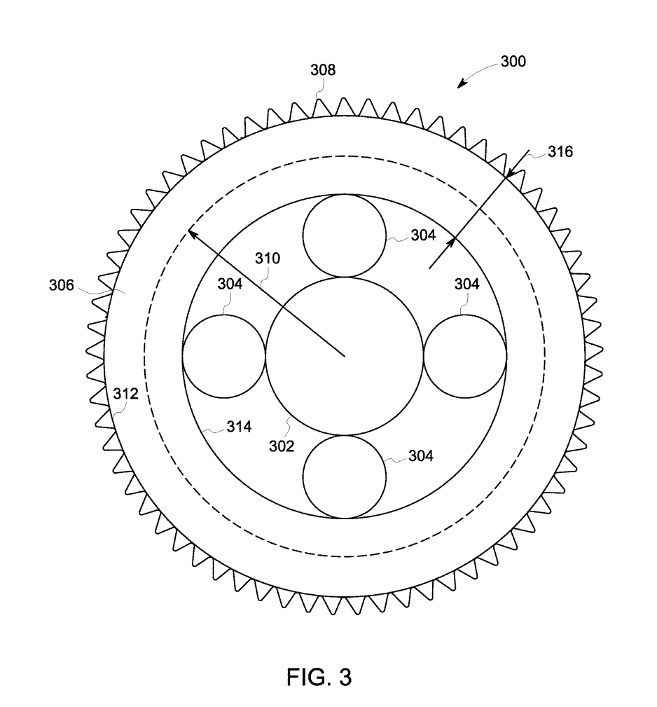

FIG. 3 is a schematic diagram of a planet gear 300. Planet gear 300 includes an inner annular bearing ring 302, a plurality of rolling elements 304, a planet gear rim 306, and a plurality of teeth 308. Planet gear rim 306 includes a planet gear bending stress neutral axis radius 310, an outer radial surface or gear root diameter 312, an inner radial surface 314, and a thickness 316. Carrier 208 (shown in FIG. 2) is coupled to inner annular bearing ring 302. Rolling elements 304 are disposed circumferentially around annular inner bearing ring 302. Planet gear rim 306 circumscribes rolling elements 304. Teeth 308 are disposed circumferentially about outer radial surface 312. Planet gear bending stress neutral axis radius 310 is the radius where the stresses and strains within planet gear rim 306 are zero when bending forces are applied to planet gear 300. Thickness 316 is the radial distance between outer radial surface or gear root diameter 312 and inner radial surface 314.

Planet gear 300 includes at least one material selected from a plurality of alloys including, without limitation, ANSI M50 (AMS6490, AMS6491, and ASTM A600), M50 Nil (AMS6278), Pyrowear 675 (AMS5930), Pyrowear 53 (AMS6308), Pyrowear 675 (AMS5930), ANSI9310 (AMS6265), 32CDV13 (AMS6481), ceramic (silicon nitride), Ferrium C61 (AMS6517), and Ferrium C64 (AMS6509). Additionally, in some emodiments, the metal materials can be nitrided to improve the life and resistance to particle damages. Planet gear 300 includes any combination of alloys and any percent weight range of those alloys that facilitates operation of planet gear 300 as described herein, including, without limitation combinations of M50 Nil (AMS6278), Pyrowear 675 (AMS5930), and Ferrium C61 (AMS6517).

During operation, depending on the configuration of epicyclic gear train 200 (shown in FIG. 2), sun gear 202 (shown in FIG. 2), ring gear 206 (shown in FIG. 2), or LP power shaft 136 rotates planet gear 300. Planet gear rim 306 rotates around rolling elements 304 and inner annular bearing ring 302. Inner annular bearing ring 302 rotates carrier 208.

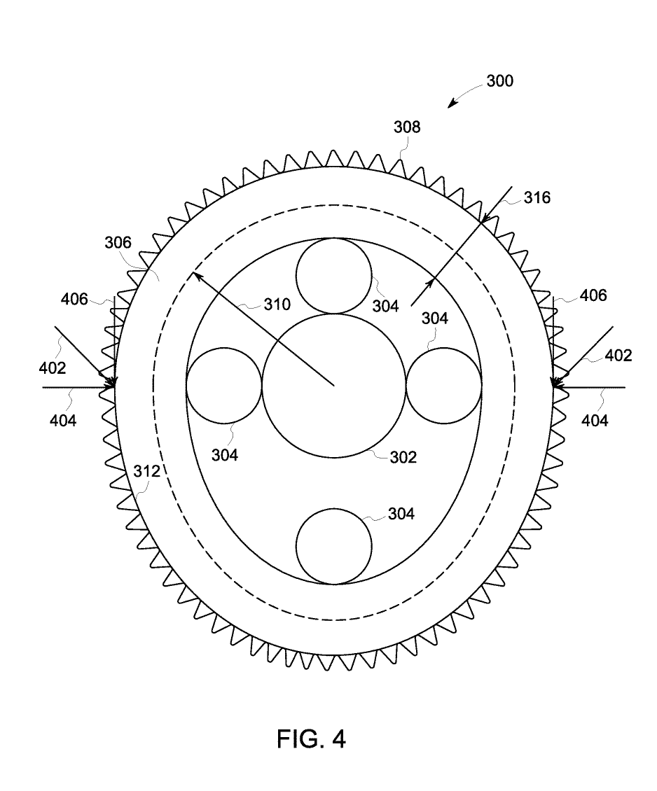

FIG. 4 is a schematic diagram of planet gear 300 (shown in FIG. 3) with resultant radial and transverse forces 402 causing a wraparound effect of bending planet gear rim 306. Torsional movement of LP power shaft 136 cause sun gear 202 (shown in FIG. 2) and ring gear 206 (shown in FIG. 2) to exert resultant radial and transverse components of gear tooth forces 402 on planet gear rim 306. Resultant radial and transverse components of gear tooth forces 402 are equal in magnitude and represent the load through teeth 308 from sun gear 202 (shown in FIG. 2) on one side and from the ring gear 206 (shown in FIG. 2) on the other side.

Resultant radial and transverse components of gear tooth forces 402 include resultant radial component forces 404 and resultant tangential component forces 406. Resultant radial component forces 404 are equal and opposite respective radial components of resultant radial and transverse components of gear tooth forces 402. Resultant tangential component forces 406 are equal respective tangential components of tooth contact forces 402. Resultant radial and transverse components of gear tooth forces 402 cause a wraparound effect of bending planet gear rim 306. The wrap around effect of bending planet gear rim 306 is caused by both resultant tangential component forces 406 pulling down and resultant radial component forces 404 pushing in. The wrap around effect of bending planet gear rim 306 distributes loads to more rolling elements 304 and, to a point, reduces the peak load on any single rolling element 304. Reduced peak load on rolling elements 304 improves the reliability of rolling elements 304 and planet gear rim 306.

Enhanced results are achieved when thickness 316 is thick enough to maintain physical integrity but thin enough to deflect. If thickness 316 is too low, planet gear rim 306 wraps around and strains teeth 308 by adding hoop stress to the tooth bending load, and driving high peak roller loads directly inboard of the gear mesh. If thickness 316 is too high, planet gear rim 306 does not deflect enough to spread resultant radial and transverse components of gear tooth forces 402 around rolling elements 304. Enhanced results are achieved when bending stress neutral axis radius 310 and thickness 316 define a ratio including values in a range from and including about 3 to and including about 10. A ratio of rim bending stress neutral axis radius 310 to thickness 316 of 3 to 10 provides enhanced distribution of resultant radial and transverse components of gear tooth forces 402 over rolling elements 304.

The above-described thin rimmed planet gear provides an efficient method for managing torsional forces in a turbomachine. Specifically, the planet gear rim deflects as resultant tangential and radial forces are applied to it from the sun gear and the low pressure power shaft and countered by the equal and opposite forces from the ring gear. Planet gear rim deflection more evenly distributes the forces across the rolling elements which reduces the peak load on any single rolling element and improves the reliability of the inner race, the rolling elements and the planet gear rim, which increases the reliability of the inner race, the rolling elements and the planet gear rim. Finally, the thin rimmed planet gear described herein reduces the weight of the aircraft by reducing the amount of material in the planet gear.

An exemplary technical effect of the methods, systems, and apparatus described herein includes at least one of: (a) decreasing the stress and strain on the planet gear rim; (b) decreasing the peak load on rolling elements; (c) increasing the reliability of the planet gear bearings; and (d) decreasing the weight of the aircraft engine.

Exemplary embodiments of the thin rimmed planet gear are described above in detail. The thin rimmed planet gear, and methods of operating such units and devices are not limited to the specific embodiments described herein, but rather, components of systems and/or steps of the methods may be utilized independently and separately from other components and/or steps described herein. For example, the methods may also be used in combination with other systems for managing torsional forces in a turbomachine, and are not limited to practice with only the systems and methods as described herein. Rather, the exemplary embodiment may be implemented and utilized in connection with many other machinery applications that require planet gears.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A planet gear comprising:
an annular planet gear ring comprising an annular planet gear rim, said annular planet gear rim having an inner radius and an outer radius, the inner radius and the outer radius defining a rim thickness therebetween, said annular planet gear rim further having a bending stress neutral axis, the bending stress neutral axis radius and the rim thickness define a ratio including values in a range from and including about 3 to and including about 10.

2. The planet gear of claim 1 further comprising a bearing, wherein said annular planetary gear ring disposed circumferentially about said bearing.

3. The planet gear of claim 2, wherein said bearing comprises a rolling element bearing.

4. The planet gear of claim 3, wherein said rolling element bearing comprises an annular inner bearing ring and a plurality of rolling elements, said plurality of rolling elements disposed circumferentially about said annular inner bearing ring, said annular planetary gear ring disposed circumferentially about said plurality of rolling elements.

5. A gear assembly comprising:
a sun gear;
a ring gear; and
a plurality of planet gears coupled to said ring gear and said sun gear, wherein each planet gear of said plurality of planet gears comprising an annular planet gear ring comprising an annular planet gear rim, said annular planet gear rim having an inner radius and an outer radius, the inner radius and the outer radius defining a rim thickness therebetween, said annular planet gear rim further having a bending stress neutral axis, the bending stress neutral axis radius and the rim thickness define a ratio including values in a range from and including about 3 to and including about 10.

6. The gear assembly of claim 5 further comprising a bearing, wherein said annular planetary gear ring disposed circumferentially about said bearing.

7. The gear assembly of claim 6, wherein said bearing comprises a rolling element bearing.

8. The gear assembly of claim 7, wherein said rolling element bearing comprises an annular inner bearing ring and a plurality of rolling elements, said plurality of rolling elements disposed circumferentially about said annular inner bearing ring, said annular planetary gear ring disposed circumferentially about said plurality of rolling elements.

9. The gear assembly of claim 8, wherein said sun gear, said plurality of planet gears, said ring gear, and said carrier configured in a planetary configuration.

10. The gear assembly of claim 8, wherein said sun gear, said plurality of planet gears, said ring gear, and said carrier configured in a star configuration.

11. The gear assembly of claim 8, wherein said sun gear, said plurality of planet gears, said ring gear, and said carrier configured in a solar configuration.

12. The gear assembly of claim 11 further comprising a power shaft coupled to said carrier.

13. The gear assembly of claim 11 further comprising a power shaft coupled to said ring gear.

14. A turbomachine comprising:
a power shaft and a gear assembly, said power shaft rotationally coupled to said gear assembly;
said gear assembly comprising:
a sun gear;
a ring gear; and
a plurality of planet gears coupled to said ring gear and said sun gear, wherein each planet gear of said plurality of planet gears comprising an annular planet gear ring comprising an annular planet gear rim, said annular planet gear rim having an inner radius and an outer radius, the inner radius and the outer radius defining a rim thickness therebetween, said annular planet gear rim further having a bending stress neutral axis, wherein the bending stress neutral axis radius and the rim thickness define a ratio including values in a range from and including about 3 to and including about 10.

15. The turbomachine of claim 14 further comprising a bearing, wherein said annular planetary gear ring disposed circumferentially about said bearing.

16. The turbomachine of claim 15, wherein said bearing comprises a rolling element bearing.

17. The turbomachine of claim 16, wherein said rolling element bearing comprises an annular inner bearing ring and a plurality of rolling elements, said plurality of rolling elements disposed circumferentially about said annular inner bearing ring, said annular planetary gear ring disposed circumferentially about said plurality of rolling elements.

18. The turbomachine of claim 17, wherein said sun gear, said plurality of planet gears, said ring gear, and said carrier configured in a planetary configuration.

19. The turbomachine of claim 17, wherein said sun gear, said plurality of planet gears, said ring gear, and said carrier configured in a star configuration.

20. The turbomachine of claim 17, wherein said sun gear, said plurality of planet gears, said ring gear, and said carrier configured in a solar configuration.
